(19) United States
(12) Patent Application Publication
(10) Pub. No.: US 2007/0005778 A1
(43) Pub. Date: Jan. 4, 2007

(54) Method for sharing contents using the webdvd technology

(76) Inventors: Yang Peng, Shanghai (CN); Declan Patrick Kelly, Eindhoven (NL); Bei Wang, Shanghai (CN); Dahua He, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/554,325

(22) PCT Filed: Dec. 18, 2003
(86) PCT No.: PCT/IB03/06130

§ 371 Date: Oct. 24, 2005

(30) Foreign Application Priority Data
Dec. 23, 2002 (CH) 02157896.6

(51) Int. Cl. G06F 15/16

(52) U.S. Cl. 709/228

(57) ABSTRACT

The present invention provides a method of sharing contents among multiple users on the Internet, using the Web-DVD technology. According to one embodiment of the invention, a method for sharing contents on the Internet is provided. In this method, a user accesses a web server via a WebDVD player/recorder and uploads contents to the web server for sharing them with other users. The user can view contents uploaded to the web server by himself or others, via the WebDVD player/recorder and selectively recording the uploaded contents via the player/recorder. The user may also selectively edit the uploaded contents via the player/recorder and submit updated contents to the web server for sharing with other users. Alternatively, the user may use his WebDVD player/recorder as a web server and enable other users to access his player/recorder to view, modify or update the shared contents.

### BACKGROUND OF THE INVENTION

The invention relates generally to a method of sharing contents, and more particularly to a method of sharing contents among multiple users using WebDVD technology.

WebDVD, also known as Internet DVD, online DVD, enhanced navigation (ENav) DVD, etc., is a powerful concept of enhancing DVD-Video with Internet technology. The DVD Forum, which is an industrial consortium (http://www.dvdforum.org), is defining a standard for web contents linked to WebDVD-Video discs. When a DVD disc containing a link to a web site is inserted into a WebDVD player, a user can gain new experience by combining the local DVD video with the Internet enhanced contents relating to this specific DVD disc. The Internet enhanced contents may include new versions of DVD menus, pictures, audio or subtitles synchronized with the local DVD video.

Since the main purpose of the WebDVD is to combine the Internet enhanced contents with movie titles from studios, WebDVD discs are usually published in a ROM format. Users can only view the Internet enhanced contents without being able to share their own contents with other users. In order to share their own contents with other users, users traditionally have to do authoring using professional authoring tools and then put up their contents on a web site to allow others to access the web site to view and download the contents. This is typically done in a PC environment. However, in the PC environment, it usually requires not only computer skills but also in-depth Internet knowledge from a user. In some cases, programming skills are also required. All of these make it too complicate for an average user.

Therefore, there is a need for a new and easy approach for sharing contents among multiple users on the Internet that will take the full advantage of the WebDVD technology.

### SUMMARY OF THE INVENTION

The present invention provides a method of sharing contents among multiple users on the Internet, using the WebDVD technology.

According to one embodiment of the invention, a method for sharing contents on the Internet is provided. The method comprises the steps of: accessing a web server via a WebDVD player/recorder; uploading contents to the web server, via the player/recorder, for sharing the contents with other users; viewing contents uploaded to the web server via the player/recorder; and selectively recording the uploaded contents via the player/recorder.

In another embodiment of the invention, the method further comprises the steps of selectively editing the uploaded contents via a WebDVD player and submitting updated contents to the web server, via the player/recorder, for sharing with other users.

In this way, a user can put up his own contents on the web server for sharing with other users and can update the contents on the server for sharing the updated contents with the other users. Alternatively, the user may use his WebDVD player/recorder as a web server and enable other users to access his player/recorder to view, modify or update the shared contents.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 shows an overview of implementing a method for sharing contents among users, in accordance with one embodiment of the invention; and

FIG. 2 is a flow chart diagram illustrating an operation of a WebDVD player/recorder, in accordance with one embodiment of the invention.

Throughout the drawings, the same reference numerals indicate similar or corresponding features or functions.

### DETAILED DESCRIPTION OF THE PREFERRED EMBODIMENTS

The present invention allows a user to put up various contents (e.g., photos, video, audio and animations) conforming to the WebDVD specification on a web site for sharing with other users. For example, any user may use a WebDVD player to view and record these shared contents on a DVD RW disc for viewing them offline at a later time. A user can even edit the downloaded contents and submit the edited version to the web site for sharing with other users. Access to the web site that contains the shared contents may be limited, via password protection, to a selected number of users, e.g., family and friends.

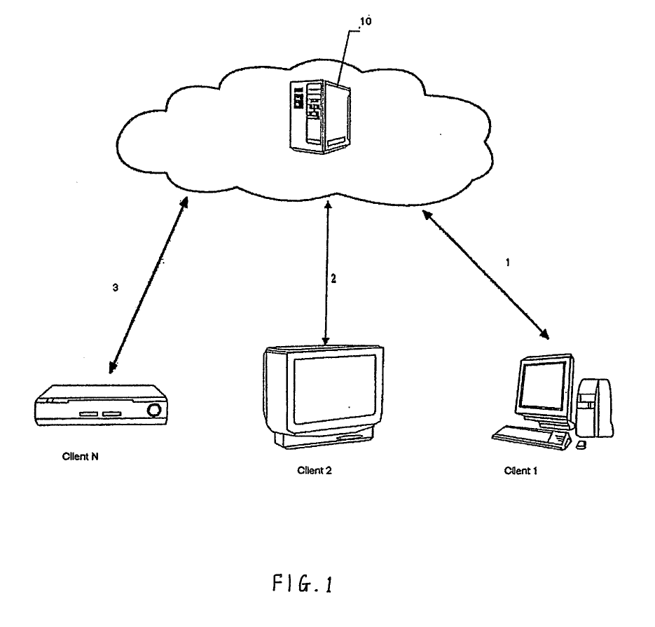

FIG. 1 shows an overview of implementing a method for sharing contents among users, in accordance with one embodiment of the invention. In FIG. 1, multiple clients including client 1, client 2, . . . , and client N are connected to the Internet and access a web server 10 to share contents among themselves. Clients 1 and 2 may be a computer and a WebDVD player (also referred to as “Enhanced Baseline Video Player”) respectively, while client N may be WebDVD player/recorder (also referred to as an “Enhanced Video Player/Recorder”). An Enhanced Baseline Video Player supports only the mandatory features specified in the WebDVD specification, while an Enhanced Video Player/Recorder supports both the mandatory and optional features specified in the WebDVD specification plus a recording feature.

To share contents with others, client 1 may upload multimedia contents (e.g., photos, video, etc.) and navigation menu conforming to the WebDVD specification to web server 10. Appropriate WebDVD authoring tools, e.g., the eDVD and DVDit from Sonic Solution in California, U.S. and the DVD Studio Pro from Apple Computers in California, U.S., may be adapted to create these contents and the navigation menu.

Client 2, which is a WebDVD player, may be linked to a related web site to access the shared contents uploaded to web server 10 by other clients, such as client 1. The URL for the web site may be available from a WebDVD disc or from a user's input. Client 2 enables a user to view the shared contents by interacting with the enhanced navigation menu available on web server 10, which is a standard feature provided by the WebDVD ROM format.

Client N, which is a WebDVD player/recorder, provides not only the normal functionalities available from a WebDVD player, but also simple “authoring” features that allow a user to edit and update the contents on the server. To use the extra functionalities of the device, a user may connect his digital camera (video or still) or other devices to the WebDVD player/recorder and design a navigation menu using the authoring features on the player/recorder. After the authoring, he may save the contents on a DVD+R or DVD+RW disc or a hard disk in the player/recorder and upload the contents to web server 10 for sharing the contents with others. The user may submit a new version of the contents to the web server by, for example, modifying the contents on the server or adding contents to the navigation menu, etc. The updated contents are again shared among users and may be recorded on optical discs along with the URL for this web site for distribution. Alternatively, the user may simply use his own WebDVD player/recorder as a web server and enable others to access the player/recorder to view, modify or update the shared contents.

In FIG. 1, the multiple clients can be synchronized in response to, e.g., remote events or commands to enable the users to chat with each other while they are viewing the same contents online, since chat is an important WebDVD feature.

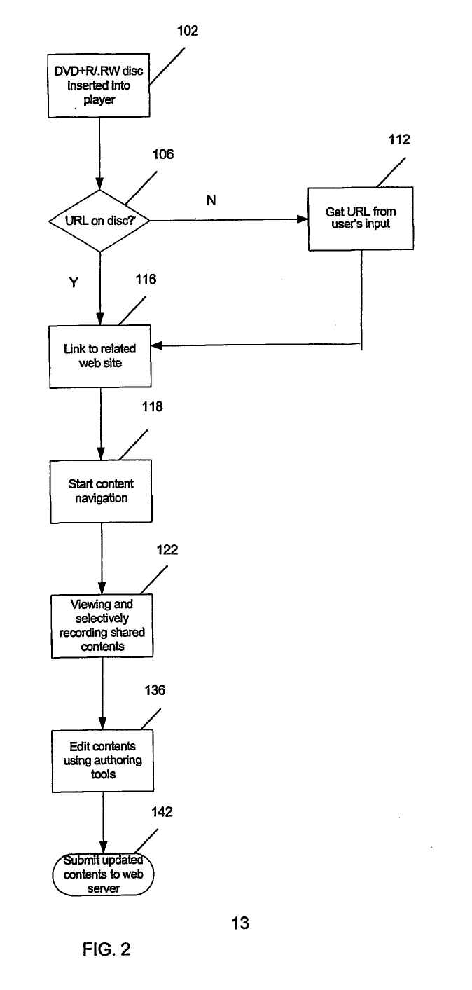

FIG. 2 is a flowchart diagram illustrating an operation of client N, a WebDVD player/recorder, in accordance with one embodiment of the invention. After an insertion of a recordable optical disc (e.g., a DVD+R or DVD+RW disc) (step 102), the player/recorder checks whether a URL for linking to a related web site is on the disc (step 106). If not, the player/recorder will wait for a user's input to get the URL (step 112). After obtaining the URL, the player/recorder will link the disc to the related web site (step 116) and download an enhanced navigation DVD menu from the web site to automatically start the content navigation (step 118). The user may view any shared contents already put up on the web server and selectively record them (step 122). The enhanced navigation menu and other contents may be recorded on either the disc or a hard disk in the player/recorder. The user can then edit the recorded contents using the WebDVD authoring tools on the player/recorder (step 136) and submit the updated contents to the web server for sharing with other users via respective clients (step 142).

In the above, for better offline playback after recording, the absolute URLs of media objects should preferably be modified to corresponding relative URLs to allow the media objects to be locally referenced.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A method for sharing contents on the Internet, comprising the steps of:
accessing a web server via a WebDVD player/recorder;
uploading contents to the web server, via the player/recorder, for sharing the contents with other users;
viewing contents uploaded to the web server via the player/recorder; and
selectively recording the uploaded contents via the player/recorder.

2. The method of claim 1, further comprising the steps of:
selectively editing the uploaded contents via a WebDVD player/recorder; and
submitting updated contents to the web server, via the player/recorder, for sharing with other users.

3. The method of claim 1, wherein the viewing step includes a step of viewing contents uploaded by multiple users.

4. The method of claim 1, wherein the uploaded contents conform to a WebDVD specification.

5. The method of claim 1, wherein the web server is accessed using a URL on the WebDVD disc.

6. The method of claim 1, wherein the web server is accessed using a URL input by a user.

7. The method of claim 1, further comprising:
before the uploading step, authoring the contents; and
after the authoring step, recording the contents in the player.

8. The method of claim 7, wherein the recording step records the contents in a recordable WebDVD disc.

9. The method of claim 7, wherein the recording step records the contents in a hard disk with a WebDVD logical format in the WebDVD player/recorder.

10. A method for sharing contents on the Internet, comprising the steps of:
authoring contents via a WebDVD player/recorder;
recording the contents via the player/recorder for sharing the contents; and
enabling other users to access the player/recorder to view and update the shared contents.

11. The method of claim 10, further comprising a step of selectively editing the contents via the player/recorder for sharing the edited contents with other users.

12. The method of claim 10, wherein the contents are authored to conform to a WebDVD specification.

13. The method of claim 10, wherein the contents are recorded in a recordable WebDVD disc.

14. The method of claim 10, wherein the contents are recorded in a hard disk with a WebDVD logical format in the player/recorder.

15. A method for sharing contents on the Internet, comprising the steps of:
authoring contents via a WebDVD player/recorder;
recording the contents via the player/recorder; and
uploading the contents to a web server, via the player/recorder, for sharing the contents with other users, the contents conforming to a WebDVD specification to the web server.

16. The method of claim 15, further comprising:
viewing contents uploaded to the web server, via the player/recorder; and
selectively recording the uploaded contents on a recordable disc via the player/recorder.

17. The method of claim 16, further comprising:
selectively editing the uploaded contents via the player/recorder; and
submitting updated contents to the web server, via the player/recorder, for sharing with other users.

18. The method of claim 17, wherein the viewing step includes a step of viewing contents uploaded by multiple users.

19. The method of claim 15, wherein the contents are recorded in a recordable WebDVD disc.

20. The method of claim 15, wherein the contents are recorded in a hard disk with a WebDVD logical format in the WebDVD player/recorder.
